(19) United States
(12) Patent Application Publication
(10) Pub. No.: US 2026/0169539 A1
(43) Pub. Date: Jun. 18, 2026

(54) STATE TRACKING AND CONTROL CIRCUITS IN AN INTEGRATED CIRCUIT (IC) AND RELATED METHODS

(71) Applicant: QUALCOMM Incorporated, San Diego, CA (US)

(72) Inventors: Pradeep Kanapathipillai, Campbell, CA (US); Nitin Makhija, San Jose, CA (US); Vinay Patel, Stouffville (CA); Daniel Ryan Rhodes, Castle Rock, CO (US); Sagar Koorapati, Longview, TX (US); Vinit Shah, San Jose, CA (US)

(21) Appl. No.: 18/983,637

(22) Filed: Dec. 17, 2024

(51) Int. Cl. G06F 1/3206; G06F 1/324; G06F 1/3296

(52) U.S. Cl. CPC G06F 1/3206; G06F 1/324; G06F 1/3296

(57) ABSTRACT

A power management circuit in an integrated circuit (IC) generates state indicators indicating respective states of logic circuits. In response to the state indicators exceeding state thresholds the power management circuit may generate suggested response signals of multiple types, where each response signal suggests a response that will reduce the state indicator that exceeded a particular state threshold by reducing activity in the logic circuits. Since more than one suggested response signal of a particular type may be generated, an accepted response signal of each response signal type is generated with the greatest magnitude among the magnitudes of the suggested response signals of the same response signal type. The power management circuit provides the accepted response signals to response circuits that correspond to the response signal type and reduce at least one of the state indicators that exceeds a state threshold.

### TECHNICAL FIELD

The technology of the disclosure relates generally to managing power consumption in integrated circuits (ICs) and in particular, to circuits for power management in a plurality of processor cores.

### BACKGROUND

Regular operation of logic circuits in a system-on-chip (SoC) or other type of integrated circuit (IC) depends on physical states, including power, voltage, current, and temperature, in and around the logic circuits. These states change during operation of the logic circuits, largely depending on circuit activity that consumes energy within particular circuits or a region of the IC. The states of associated circuits, such as processor cores within a cluster, can be monitored and compared to thresholds and when a state approaches or exceeds a threshold condition, a signal indicating the situation may be generated to trigger a response that will, in some manner, reduce the energy consumption or rate of energy consumption within the cluster. However, latency between the detection of a state reaching a threshold condition and a subsequent corrective action may allow a condition to get worse and may result in circuit failures, which may be operational errors or even permanent circuit damage. Consequently, a margin may be added to the threshold to ensure that, in view of the latency, corrective action can be taken before the state condition causes errors or damage. A margin of this nature limits performance because the logic circuits are kept well below peak operating levels.

### SUMMARY

Aspects disclosed in the detailed description include state tracking and control circuits in an integrated circuit (IC). Related methods of state tracking and circuit control are also disclosed. In response to increases in activity and/or sustained elevated levels of activity, logic circuits may develop certain states that interfere with normal operation and are potentially harmful to the logic circuits. There is a long latency involved in responding to such states through software control. Consequently, a logic circuit may be required to operate well below peak performance to avoid errors and/or damage that would otherwise occur when such states are detected.

An exemplary power management circuit in an IC generates state indicators indicating the respective states of logic circuits. In response to the state indicators exceeding state thresholds, the power management circuit may generate suggested response signals of multiple types, where each response signal suggests a response that will reduce the state indicator that exceeded a particular state threshold by reducing activity in the logic circuits. Since more than one suggested response signal of a particular type may be generated, an accepted response signal of each response signal type is generated with the greatest magnitude among the magnitudes of the suggested response signals of the same response signal type. The power management circuit provides the accepted response signals to response circuits that correspond to the response signal type and reduces at least one of the state indicators that exceeds a state threshold. The accepted response signals may be provided directly to the response circuits without software support. In some examples, the response circuits include the logic circuits, a clock control circuit, and a voltage control circuit. A low latency, multi-faceted response to states that exceed a threshold allows the logic circuits to operate at a higher performance level with a reduced risk of operational failure and/or circuit damage.

In this regard, in one aspect, an IC is disclosed. The IC includes a power management circuit. The power management circuit is configured to generate state indicators indicating respective states of logic circuits in an IC and, in response to the state indicators exceeding a state threshold, generate suggested response signals that each have a corresponding magnitude and a corresponding response signal type. The power management circuit is further configured to, for each response signal type, determine a greatest magnitude among magnitudes of the corresponding suggested response signals, generate an accepted response signal having the greatest magnitude, and provide the accepted response signal to a response circuit corresponding to the response signal type and configured to reduce at least one of the state indicators exceeding the state threshold.

In another aspect, a method of a power management circuit in an IC is disclosed. The method includes generating state indicators indicating respective states of logic circuits in an IC and, in response to the state indicators exceeding a state threshold, generating suggested response signals that each has a corresponding magnitude and a corresponding response signal type. The method further comprises, for each response signal type, determining a greatest magnitude among magnitudes of the corresponding suggested response signals, generating an accepted response signal having the greatest magnitude, and providing the accepted response signal to a response circuit corresponding to the response signal type and configured to reduce at least one of the state indicators exceeding a state threshold.

### BRIEF DESCRIPTION OF THE DRAWINGS

FIG. 1 is a diagram of an integrated circuit (IC), which may be a system-on-chip (SoC), including clusters of logic circuits, such as processor cores, that include exemplary power management circuits to monitor circuit states and adjust circuit activity with low latency to maintain a higher level of performance;

FIG. 2 is a diagram of a processor core that may be one of a plurality of processor cores in the clusters in the IC in FIG. 1;

FIG. 3 is a schematic diagram of an exemplary cluster as shown in FIG. 1 including a power management circuit for monitoring and controlling circuits with reduced latency, which allows circuits to operate closer to threshold levels;

FIG. 4 is a schematic diagram of a state tracker circuit that may be employed in the power management circuit to detect a circuit state and provide at least one type of response;

FIG. 5 is a chart of state tracker circuits that may be employed in a power management circuit to monitor various circuit states over a range of time periods;

FIG. 6 is a flowchart of a method of a power management circuit for monitoring and controlling states of logic circuits in an IC;

FIG. 7 is a block diagram of an exemplary wireless communication device that includes a power management circuit to monitor circuit states and adjust circuit activity with low latency to maintain a higher level of performance; and

FIG. 8 is a block diagram of an exemplary processor-based system that can include a power management circuit to monitor circuits state and adjust circuit activity with low latency to maintain a higher level of performance.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include state tracking and control circuits in an integrated circuit (IC). Related methods of state tracking and circuit control are also disclosed. In response to increases in activity and/or sustained elevated levels of activity, logic circuits may develop certain states that interfere with normal operation and are potentially harmful to the logic circuits. There is a long latency involved in responding to such states through software control. Consequently, a logic circuit may be required to operate well below peak performance to avoid errors and/or damage that would otherwise occur when such states are detected.

An exemplary power management circuit in an IC generates state indicators indicating respective states of logic circuits. In response to the state indicators exceeding state thresholds the power management circuit may generate suggested response signals of multiple types, where each response signal suggests a response that will reduce the state indicator that exceeded a particular state threshold by reducing activity in the logic circuits. Since more than one suggested response signal of a particular type may be generated, an accepted response signal of each response signal type is generated with the greatest magnitude among the magnitudes of the suggested response signals of the same response signal type. The power management circuit provides the accepted response signals to response circuits that correspond to the response signal type and reduce at least one of the state indicators that exceeds a state threshold. The accepted response signals may be provided directly to the response circuits without software support. In some examples, the response circuits include the logic circuits, a clock control circuit, and a voltage control circuit. A low latency, multi-faceted response to states that exceed a threshold allows the logic circuits to operate at a higher performance level with a reduced risk of operational failure and/or circuit damage.

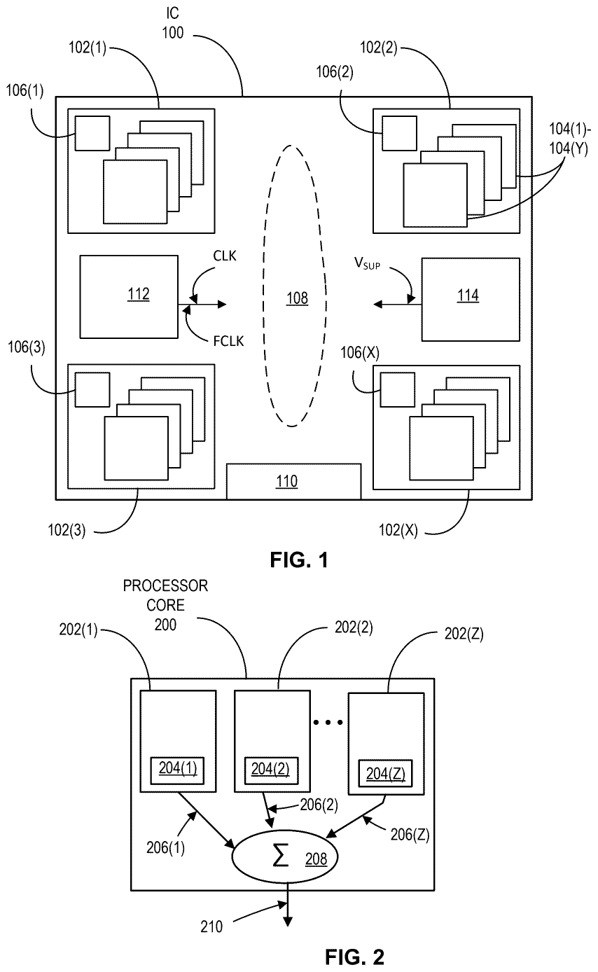

FIG. 1 is a diagram of an IC 100, which may be a system-on-chip (SoC) that includes clusters 102(1)-102(X) of logic circuits 104(1)-104(Y). The number Y of the logic circuits 104(1)-104(Y) (shown in FIG. 1 in cluster 102(2)) may not be the same in each of the clusters 102(1)-102(X). The clusters 102(1)-102(X) may include exemplary power management circuits 106(1)-106(X) to monitor circuit states and adjust circuit activity with low latency to maintain a higher level of performance. The states of the circuits that may be monitored include, for example, current levels, rates of change of current, voltage levels, rates of change of voltage, power, temperature, etc. These monitored states may be compared to corresponding thresholds that represent potentially problematic situations for the IC 100. In response to one or more of the monitored states reaching a threshold, the circuit activity may be adjusted to return the monitored state to a normal range. Adjustments in this regard may include reducing a clock frequency of a clock to the logic circuits 104(1)-104(Y), adjusting a voltage, or throttling the execution of instructions.

The clusters 102(1)-102(X) may be interconnected by a communication mesh or network 108 and may be able to access memory circuits (not shown) external to the IC 100 through a memory interface 110. The memory interface 110 may include independent connections to multiple external memories. Other external interfaces may also be included in the IC 100.

The clusters 102(1)-102(X) may include cache circuits (not shown) for temporarily storing software instructions to be executed by the logic circuits 104(1)-104(Y) and the corresponding data. For a better user experience, many applications require high performance processing, which may require that the logic circuits 104(1)-104(Y) operate at a high frequency. The frequency of operation of the logic circuits 104(1)-104(Y) depends, at least in part, on a clock frequency FCLK of a clock signal CLK, which may be provided to the logic circuits 104(1)-104(Y) by a clock control circuit 112. The clock signal CLK may be provided to each of the logic circuits 104(1)-104(Y) to synchronize their operation and communications. As the clock frequency FCLK of the clock signal CLK increases, the logic circuits 104(1)-104(Y) switch more frequently, where switching involves charging and discharging of circuits and circuit nodes. As circuits are charged up and then discharged, power is consumed. Thus, higher frequency operation corresponds to a higher power consumption.

When activity suddenly increases, the current level can suddenly increase (di/dt) and cause a droop in voltage in the IC 100. As current levels and voltage levels increase to provide more power, current and voltage thresholds for the IC 100 may be approached and/or exceeded. Increased power consumption also increases heating in the IC 100, which can hinder performance and may damage the IC 100 at high temperatures. Thus, the power management circuits 106(1)-106(X) may include the ability to monitor states (e.g., electrical and thermal states) in the respective clusters 102(1)-102(X) and take actions to mitigate or control the negative impacts of higher performance operation.

For example, the logic circuits 104(1)-104(Y) in any or all of the clusters 102(1)-102(X) may be throttled to the same or different degrees, whereby throttling may cause activity to be suspended in a first number of cycles (e.g., periodically) among a second number of cycles. For example, throttling may cause execution to be suspended in 1 out of every 4, 8, or 16 cycles of the clock signal CLK. In situations in which a more aggressive response may be needed, the throttling may cause execution to occur in 1 cycle out of 2, 4, or 8 consecutive cycles, for example. It should be apparent that the throttling can range from mild to aggressive. In some examples, the clock frequency FCLK of the clock signal CLK may be reduced to slow activity in the IC 100. In other examples, a power control circuit 114 in the IC 100 may be signaled to adjust a power level, such as a voltage level or current level of a power signal V_{SUP}.

FIG. 2 is a diagram of a processor core 200 that may be one of the logic circuits 104(1)-104(Y) in any of the clusters 102(1)-102(X) in FIG. 1. The processor core 200 includes multiple logic blocks 202(1)-202(Z), which may include, for example, instruction fetch units, rename units, vector units, load/store units, instruction execution units, memory management units, etc. In this context, the term “logic block” refers to a block or group of logic circuits, such as transistor-based circuits. Activity in the logic blocks 202(1)-202(Z) includes architectural events of the processor core 200 and each of such events may cause the logic blocks 202(1)-202(Z) to consume a specific amount of energy or require an amount of power for a number of cycles. Through testing and simulation, for example, information regarding an amount of energy consumed by each of such events or activity is determined. Each of the logic blocks 202(1)-202(Z) includes a block aggregator 204(1)-204(Z) that generates indications 206(1)-206(Z) of the activity in each of the logic blocks 202(1)-202(Z) based on the activity performed therein. The block aggregators 204(1)-204(Z) may also receive and aggregate information on energy consumption due to activity in other logic blocks (not shown) that do not include their own block aggregator. The processor core 200 also includes a core aggregator 208 that receives and aggregates the indications 206(1)-206(Z) to generate an indication of activity 210 in the processor core 200, where the indication of activity 210 may indicate the activity in the processor core 200 in units of energy (e.g., joules) or electrical charge (e.g., coulombs) or in a normalized unitless value that may be converted to energy or charge.

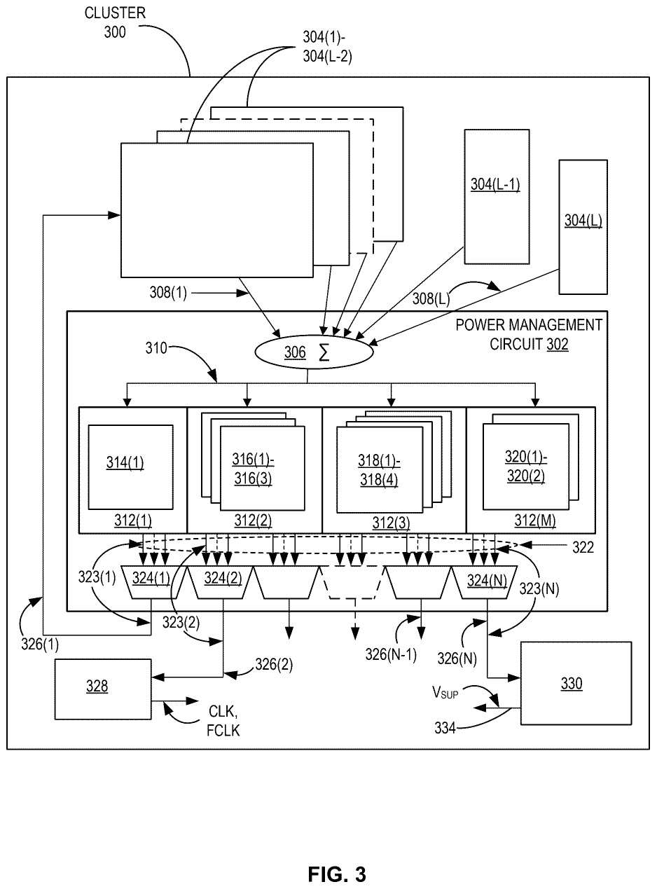

FIG. 3 is a schematic diagram of an exemplary cluster 300 that may be any of the clusters 102(1)-102(X) in FIG. 1 and includes a power management circuit 302 for monitoring and controlling a plurality of logic circuits 304(1)-304(L) with reduced latency. The power management circuit 302 controls the logic circuits 304(1)-304(L) to operate close to threshold levels of monitored states. The logic circuits 304(1)-304(L-2) may each be the processor core 200 in FIG. 2 or may collectively be the logic circuits 104(1)-104(Y) in FIG. 1. The logic circuit 304(L-1) in FIG. 3 is a cache memory circuit that may provide a lowest level of cache for the logic circuits 304(1)-304(L-2). The logic circuit 304(L) in this example is a bus interface circuit for coupling the logic circuits 304(1)-304(L-2) to a system bus or network, such as the communication mesh/network 108 in FIG. 1. The logic circuits 304(1)-304(L) may include alternative and/or additional types of circuits appropriate for a cluster in a system on an IC.

The power management circuit 302 includes a cluster aggregator 306 that receives and aggregates indications of activity 308(1)-308(L) in each of the plurality of logic circuits 304(1)-304(L) to generate an aggregated activity indicator 310. The logic circuits 304(1)-304(L) may represent the entirety or just a subset of the circuits in the cluster 300. In the example in FIG. 3, there is a single cluster aggregator 306 that generates the aggregated activity indicator 310, which is a sum of all the indications of activity 308(1)-308(L) from all the logic circuits 304(1)-304(L) in a cluster, and an adjustment to the activity in the cluster may be made based on that sum. In other examples, there may be multiple cluster aggregators 306 within a cluster, where each cluster aggregator sums the indications of activity in a respective subset of the logic circuits 104(1)-104(Y) and individual responses may be generated to adjust each subset accordingly.

The indications of activity 308(1)-308(L) may be the indication of activity 210 in FIG. 2 indicating levels or amounts of activity in the logic circuits 304(1)-304(L) based on the energy or power consumed during events therein and the aggregated activity indicator 310 may indicate a total level or amount of activity, which corresponds to energy or charge consumption, for the cluster 300. The indications of activity 308(1)-308(L) may also represent a subset of the activity for the cluster 300 and may be one of several aggregators in the cluster. The duplication allows for tracking of individual subsets of the circuits in cluster 300. The cluster aggregator 306 may convert the indications of activity 308(1)-308(L) to appropriate units before generating the aggregated activity indicator 310.

Though not shown herein, the cluster aggregator 306 may be one of two or more cluster aggregators in the cluster 300, and each cluster aggregator may receive a distinct subset of indications of activity similar to the indications of activity 308(1)-308(L) from a distinct subset of logic circuits in the cluster 300. In addition, responses may be generated independently based on each of such cluster aggregators. In this manner, the tracking of activity in the cluster 300 and the response thereto may be handled at a more granular level to increase flexibility of the power management circuit 302. The power management circuit 302 includes state trackers 312(1)-312(M) that track (e.g., monitor and/or measure) states in the cluster 300 based on the aggregated activity indicator 310. A significant feature of the state trackers 312(1)-312(M) is that each one derives different state information from the aggregated activity indicator 310, which is a sum of the normalized unitless value described above. For example, one of the state trackers 312(1)-312(M) that monitors the aggregated activity indicator 310 over periods of a few (e.g., 64 to 128) clock cycles can recognize changes in the aggregated activity indicator 310 as changes in current level (e.g., di/dt). To limit the severity of voltage droop or surge in response to a current surge, an immediate response (e.g., <20 nanoseconds) is needed and cannot be achieved by requesting a software response. As described herein, the power management circuit 302 may respond quickly by generating signals directly to hardware circuits to adjust activity in the cluster.

Other examples of the state information that may be derived by the state trackers 312(1)-312(M) includes a cumulative current level (e.g., maximum) across multiple power rails, and individual current levels of the power rails over different windows of time (e.g., 1 microsecond and 5 microseconds). Further examples include deriving cluster level average power over different windows of time (e.g., 1-2 microseconds and longer) and individual power averages for the logic circuits 304(1)-304(Y). One of the state trackers 312(1)-312(M) may be able to derive/infer changes in temperature based on the aggregated activity indicator 310.

Each of the state trackers 312(1)-312(M) can be allocated to the entire cluster or there may be one for each of a plurality of subsets of the cluster. For example, there may be multiple state trackers 312(1)-312(M) of a particular type (i.e., monitor a particular one of the information discussed above) associated with each of the logic circuits 304(1)-304(Y), associated with groups of the logic circuits, or associated with geographic areas of the cluster.

Since the states derived by the state trackers 312(1)-312(M) are all based on the aggregated activity indicator 310, all of those states can be adjusted by a response that affects the aggregated activity indicator 310. Responses affecting the aggregated activity indicator 310 may include, but are not limited to, an adjustment to a frequency of the system clock, an adjustment to a voltage level on one or more power rails, and/or a throttling of instruction execution in the logic circuits 304(1)-304(Y). Each of these adjustments reduces the rate at which energy is consumed in the logic circuits 304(1)-304(Y).

In this example, the state tracker 312(1) includes one state tracker circuit 314(1), the state tracker 312(2) includes three state tracker circuits 316(1)-316(3), the state tracker 312(3) includes four state tracker circuits 318(1)-318(4), and the state tracker 312(M) includes two state tracker circuits 320(1)-320(2). The state tracker circuit 314(1), state tracker circuits 316(1)-316(3), state tracker circuits 318(1)-318(4), and state tracker circuits 320(1)-320(2) may be referred to herein collectively as the state tracker circuits 314-320. There may be any number M (where M=4 in this example) of different types of state trackers 312(1)-312(M) configured to track M different states, and there may be any appropriate number of state tracker circuits in each type of the state trackers 312(1)-312(M).

As noted above, the state trackers 312(1)-312(M) each track or measure a state in the entire cluster 300 or in a subset of logic circuits in the cluster 300. In this context, the determined (e.g., measured) states may include, for example, a rate of change of current (di/dt) on a power rail 334 providing power to the logic circuit 304(1)-304(L). In some examples, there may be state tracker circuits for tracking each of a plurality of power rails in the cluster 300. The tracked states may include instantaneous power, current, voltage, or temperature over one or more periods of time. Other states that can be determined from the aggregated activity indicator 310 may also be tracked.

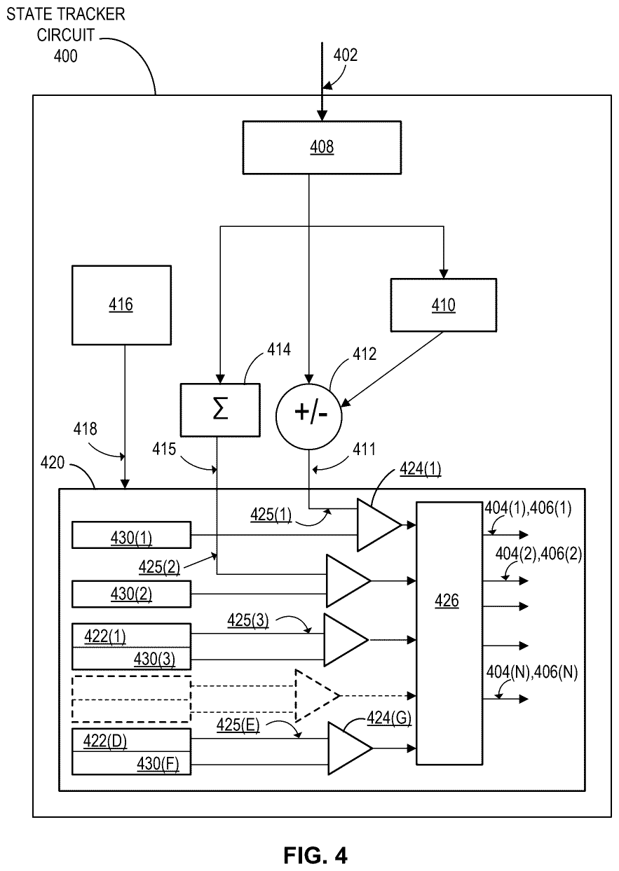

As described in more detail with reference to FIG. 4, the state tracker circuits 314-320 in the power management circuit 302 generate state indicators that indicate respective states (also referred to herein as tracked states) of the logic circuits 304(1)-304(L). The tracked states may include current, voltage, power, and/or temperature information and the state indicators may be measurements or estimates of states based on the aggregated activity indicator 310. Based on magnitudes of the tracked states, the state trackers 312(1)-312(M) determine appropriate responses. The responses generated by the state trackers 312(1)-312(M) are suggested response signals 322 that are each one of a response signal type 323(1)-323(N). Each of the response signal types 323(1)-323(N) is directed to adjusting the state indicators by adjusting activity in the logic circuits, which is measured by the aggregated activity indicator 310. There are a limited number (e.g., N) of response signal types 323(1)-323(N), so the suggested response signals 322 of each of the state trackers 312(1)-312(M) are one of the response signal types 323(1)-323(N). Thus, more than one of the state trackers 312(1)-312(M) may generate a response of a same response signal type 323(1)-323(N) in a same clock cycle.

In this regard, more than one of the state tracker circuits 314-320 may generate a response in the form of a suggested response signal 322 of a first response signal type 323(1) (or any of the response signal types 323(1)-323(N)) in a same cycle of the system clock. Since there may be multiple suggested response signals 322 of a same one of the response signal type 323(1), one of the suggested response signals 322 may have a greater magnitude than all the others. In this context, a suggested response signal 322 having a greater magnitude may be suggesting a higher level of response (i.e., suggesting a more significant change to the aggregated activity indicator 310) than the other control signals 322 of the same type from other state tracker circuits 314-320. For this reason, the power management circuit 302 includes voting circuits 324(1)-324(N) that receive each of the suggested response signals 322 of all of the response signal types 323(1)-323(N) and generate accepted response signals 326(1)-326(N) for each type. The voting circuits 324(1)-324(N) determine a greatest magnitude among magnitudes of the suggested response signals 322 of a same response signal type 323(1)-323(N) and the accepted response signals 326(1)-326(N) have the greatest magnitude. In other words, the accepted response signals 326(1)-326(N) are based on the winners of the voting among each of the suggested response signals 322 of the response signal types 323(1)-323(N). Thus, the accepted response signals 326(1)-326(N) each have a corresponding magnitude and a corresponding response signal type 323(1)-323(N). The voting circuit 324(1), as an example, generates an accepted response signal 326(1) having a magnitude that is equal to the greatest magnitude of all the suggested response signals 322 of the response signal type 323(1).

In addition, depending on a level (e.g., magnitude) of a state or a rate of change of a state in a period of time, multiple suggested response signals 322 may be generated by one of the state tracker circuits 314-320. For example, it may be determined that responding only by a change in the frequency of instruction execution may not provide an adequate change to a tracked state, so a single state tracker 312(x) may generate multiple responses (e.g., suggested response signals 322). In some examples, multiple state trackers 312(1)-312(M) will each generate multiple suggested response signals 322 of different types. For example, all the suggested response signals 322 of a same type (e.g., 323(1)) may be provided to the voting circuits 324(1) employed for that type (323(1)) to generate the accepted response signal 326(1) of that type (323(1)).

The accepted response signals 326(1)-326(N) for each response signal type 323(1)-323(N) are provided to a response circuit that corresponds to the response signal type 323(1)-323(N) and is configured to reduce at least one of the state indicators exceeding a state threshold. The term “response circuit” as used herein refers to any hardware circuit that can directly reduce the rate of power consumption in the cluster 300. In some examples, the accepted response signals 326(1)-326(N) may be provided directly to one or more of the logic circuits 304(1)-304(L) to throttle instruction execution. Alternatively, the accepted response signals 326(1)-326(N) may be provided to other circuits to reduce activity in the logic circuits 304(1)-304(L). The accepted response signals 326(1)-326(N) may each have a range of values to indicate a range of responses that include a minor adjustment up to a drastic adjustment and different adjustment levels in between.

The cluster 300 also includes a clock control circuit 328 that may throttle a clock signal CLK. For example, the clock control circuit 328 may adjust (e.g., reduce) a clock frequency FCLK of the clock signal CLK in response to one of the accepted response signals 326(1)-326(N). The clock frequency FCLK may be adjusted to a small or great extent, or somewhere in between, depending on a value of the accepted response signals 326(1)-326(N). In another example, the cluster 300 includes a cluster-level power control circuit 330 that provides a power signal V_{SUP} to the cluster 300 on a power rail 334. The power control circuit 330 may adjust power in some manner (e.g., current, voltage, or both on the power rail 334) at the cluster level in response to one of the accepted response signals 326(1)-326(N). The power control circuit 330 may adjust the power signal V_{SUP} to the entire cluster 300 or to a subset of the cluster 300, such as one of the logic circuits 304(1)-304(L). The extent of change to the power may depend on a value of the accepted response signals 326(1)-326(N). In some examples, the cluster 300 may include a second power control circuit to provide power to one power rail while the power control circuit 330 provides power to another power rail, for example. Any number of cluster-level power control circuits may be considered and individually controlled. For example, the cluster 300 may include more than one power rail (not shown), having different voltages or power modes, where each power rail is provided power by a different cluster-level power control circuit 330. The accepted response signals 326(1)-326(N) may include power control signals to be provided to a first cluster power control circuit 330 providing a first power signal V_{SUP} (“first cluster power signal”) to a first power rail 334 in the cluster 300 and to a second cluster-level power control circuit 330 providing a second power signal V_{SUP} (“second cluster power signal”) to a second power rail 334 in the cluster 300.

The accepted response signals 326(1)-326(N) may be provided directly to the response circuits, which include the logic circuits 304(1)-304(L), the clock control circuit 328, and the power control circuit 330. Throttling the logic circuits 304(1)-304(L), reducing the clock frequency FCLK, and reducing a supply voltage V_{SUP} may be employed to directly reduce the rate of power consumption, which will reduce any of the state indicators or tracked states in the cluster 300. The accepted response signals 326(1)-326(N) may include throttle signals to cause a throttling (e.g., reduction) of activity in the logic circuits 304(1)-304(L). For example, throttling may involve blocking execution within one or more of the logic circuits 304(1)-304(L) in some percentage of the cycles of the clock signal CLK. This may continue for some number of clock cycles or until the accepted response signals 326(1)-326(N) are adjusted again.

In response to each of the accepted response signals 326(1)-326(N), activity in the logic circuits 304(1)-304(L) is reduced in one or more ways. In some examples, when more than one of the accepted response signals 326(1)-326(N) are provided at the same time (e.g., in the same cycle of the clock signal CLK), activity may be reduced based on each of such accepted response signals 326(1)-326(N) in parallel. For example, the accepted response signals 326(1)-326(N) may include clock control signals provided to the clock control circuit 328 and power control signals to the power control circuit 330 to cause a reduction in activity based on a reduced clock frequency FCLK and reduction in power level in parallel. As another example, the accepted response signals 326(1)-326(N) include a clock control signal that may cause throttling in one or more of the logic circuits 304(1)-304(L) in parallel to reducing the clock frequency FCLK or reducing power provided to the cluster 300 (or reducing both).

In some examples, the accepted response signals 326(1)-326(N) may include a firmware control signal to trigger a firmware response, wherein reduction of activity in the cluster 300 depends on execution of firmware instructions in a processor or processing circuit. In some examples the accepted response signals 326(1)-326(N) may include an IC power signal provided to an IC power circuit, such as the power control circuit 114 in FIG. 1, to adjust power to the IC that includes the cluster 300.

FIG. 4 is a schematic diagram of a state tracker circuit 400 that may be any one of the state tracker circuits 314-320 employed in the power management circuit 302 in FIG. 3 to receive an aggregated activity indicator 402. The aggregated activity indicator 402 may be the aggregated activity indicator 310 in FIG. 3 described above, and may generate one or more suggested response signals 404(1)-404(N) of at least one response signal type 406(1)-406(N).

The aggregated activity indicator 402 may be received in each cycle of the clock signal CLK (not shown) in a first storage circuit 408 in which the aggregated activity indicator 402 is stored and may be converted to different units, as needed. The state tracker circuit 400 includes a second storage circuit 410 to hold the aggregated activity indicator 402 from a previous cycle of the clock signal CLK. A comparator 412 may be used to determine a cycle-to-cycle change 411 in the aggregated activity indicator 402. In addition, the state tracker circuit 400 includes a summing circuit 414 that may be configured to generate a sum 415 of the aggregated activity indicator 402 for a window (or multiple windows) of time (e.g., based on a programmable number of cycles). The first storage circuit 408, the second storage circuit 410, and the summing circuit 414 may be updated in every cycle of the clock signal CLK. A cycle-to-cycle change 411 determined by the comparator 412 may also be updated every cycle.

The state tracker circuit 400 also includes a bank of configuration registers 416 that may provide various information to be used in the evaluation of the aggregated activity indicator 402. For example, the configuration registers 416 may include a timebase indicator 418 that may be used, for example, to indicate the frequency FCLK (not shown) of the clock signal CLK so that time may be measured by cycles of the clock signal CLK. The timebase indicator 418 may also be used for synchronization and/or other purposes.

The state tracker circuit 400 includes a compare/control circuit 420 that receives the cycle-to-cycle change 411, the sum(s) 415, and any information programmed into the configuration registers 416, such as the timebase indicator 418. The state tracker circuit 400 also includes state calculation circuits 422(1)-422(D) that may be programmable logic circuits used to generate some of the state indicators 425(1)-425(E). The state indicators 425(1)-425(E) are each a measurement or estimate of a corresponding physical state or condition, which may be determined from the aggregated activity indicator 402. The state indicators 425(1)-425(E) may include a level, a change or a rate of change of current, voltage, or temperature in one or more time periods. The compare/control circuit 420 may compare the state indicators 425(1)-425(E) to corresponding state thresholds 430(1)-430(F) associated with the state calculation circuits 422(1)-422(D) and identify the state thresholds 430(1)-430(F) that are exceeded by the state indicators 425(1)-425(E). In some cases, there may be multiple state thresholds 430(1)-430(F), such as a low, medium, and high threshold compared to one of the state indicators 425(1)-425(E). In this regard, the compare/control circuit 420 includes comparators 424(1)-424(G) that compare the state indicators 425(1)-425(E) to their respective state thresholds 430(1)-430(F), which may be stored in the state calculation circuits 422(1)-422(D) and determine whether one or more state thresholds 430(1)-430(F) have been exceeded.

The state tracker circuit 400, which may also be referred to as a programmable state tracker circuit 400, also includes a response circuit 426 that may be programmable to uniquely specify, for each of the state thresholds 430(1)-430(F), how the compare/control circuit 420 will respond when a state threshold 430(1)-430(F) is exceeded by the state indicator 425(1)-425(E). The response circuit 426 may be included in the compare/control circuit 420. Thus, each of the state tracker circuits 400 may be programmable to generate any one or more of the response signal types 406(1)-406(N). Depending on a magnitude of the aggregated activity indicator 402 and the state thresholds 430(1)-430(F) exceeded by the state indicators 425(1)-425(E), the compare/control circuit 420 may adjust a magnitude of at least one of the suggested response signals 404(1)-404(N), which respectively have response signal types 406(1)-406(N). The suggested response signals 404(1)-404(N) may be the suggested response signals 322 in FIG. 3. Since a magnitude of a state indicator 425(1)-425(E) may be indicated by the comparators 424(1)-424(G) determining that one or more state thresholds 430(1)-430(F) have been exceeded, the response circuit 426 may generate one or more suggested response signals 404(1)-404(N) in response to each one of the exceeded state thresholds 430(1)-430(F), or in response to only the highest one of the exceeded state thresholds 430(1)-430(F). For example, when a low threshold is exceeded by a state indicator 425(1)-425(E), a first suggested response signal 404(1) may slightly throttle a logic circuit. As medium and higher thresholds are exceeded by state indicators 425(1)-425(E), more of the suggested response signals 404(1)-404(N) may be used to implement other control measures, such as reduction of the clock frequency FCLK and the power signal V_{SUP} shown in FIG. 3. The suggested response signals 404(1)-404(N) may also be employed to alert firmware or a service processor of a situation that requires a greater level of response. In some examples, there may be a single threshold for a calculated value and the programmable response may involve generating one or more of the suggested response signals 404(1)-404(N) to reduce activity by various approaches.

Referring back to FIG. 3 as well as to FIG. 4, there may be many state tracker circuits 400 in the power management circuit 302 and each state tracker circuit 400 may generate the suggested response signals 404(1)-404(N) in every cycle. The voting circuits 324(1)-324(N) determine, for a particular one of the suggested response signals (e.g., 404(1)) from all the state tracker circuits 400, the greatest request for reduction in activity to address a detected state (e.g., highest requested throttling level) and generate the corresponding accepted response signal (e.g., 326(1)-326(N)) based on that greatest request. In other words, the suggested response signals 404(1)-404(N) are requests for changes to reduce activity in the logic circuits 304(1)-304(L) in FIG. 3 based on various detected states, and the accepted response signals 326(1)-326(N) should address the requests for the greatest one of the requested changes to ensure that the most problematic detected state is addressed or mitigated.

For each of the response signal types 323(1)-323(N), the power management circuit 302 provides the corresponding accepted response signals 326(1)-326(N) to a response circuit that corresponds to the response signal type 323(1)-323(N) and is configured to reduce at least one of the state indicators 425(1)-425(E) exceeding a state threshold 430(1)-430(F). For example, the logic circuits 304(1)-304(L) correspond to accepted response signals 326(1)-326(N) having a response signal type 323(1)-323(N) associated with throttling instruction execution. The clock control circuit 328 in FIG. 3 corresponds to accepted response signals 326(1)-326(N) having a response signal type 323(1)-323(N) associated with reducing clock frequency FCLK. The power control circuit 330 corresponds to accepted response signals 326(1)-326(N) having a response signal type 323(1)-323(N) associated with reducing current, voltage, and/or power in the cluster 300. Each of the logic circuits 304(1)-304(L), the clock control circuit 328, and the power control circuit 330 are configured to reduce any of the state indicators 425(1)-425(E).

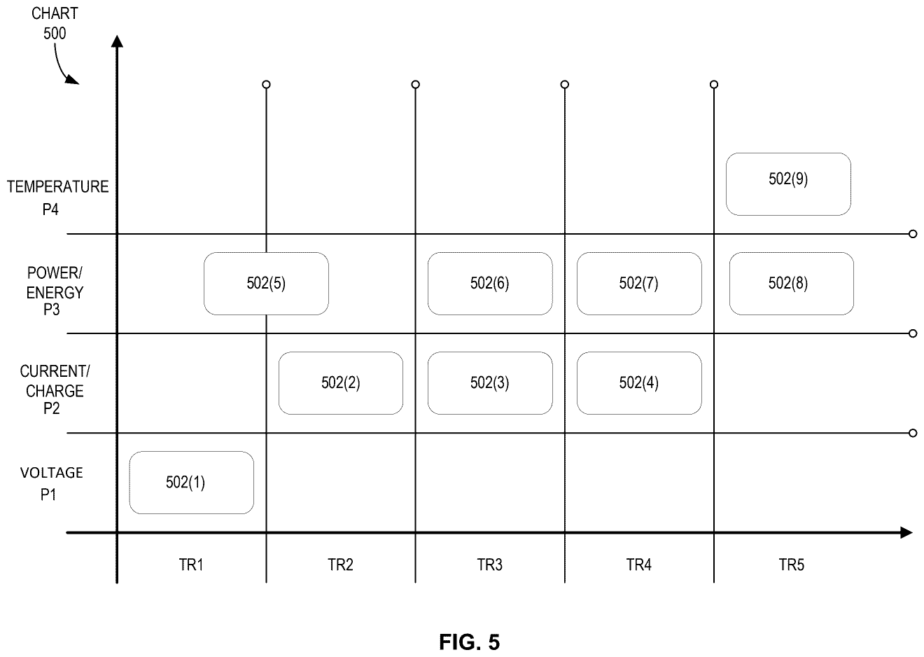

FIG. 5 is a chart 500 of examples of state tracker circuits (STCs) 502(1)-502(9) that may be the state tracker circuits 400 in FIG. 4 or the state tracker circuits 314-320 in FIG. 3. The STCs employed in the power management circuit 302 are not limited to those described herein or limited to the categories described. In chart 500, STCs 502(1)-502(9) are arranged in columns of time ranges TR1-TR5 and physical types P1-P4. For example, the STC 502(1) is provided to anticipate a voltage droop (physical type P1) in the power signal V_{SUP} on a voltage rail by monitoring current in the power rail to detect a sudden increase (e.g., di/dt). The power management circuit 302 in FIG. 3 can detect a current spike and respond quickly by reducing the current draw, increasing the power provided to the power rail, or any other appropriate response, which may include a combination of responses. The STC 502(1) is evaluated over a short period of time (e.g., <10 nanoseconds) as indicated by the time range TR1.

The STCs 502(2)-502(4) may each be used to check limits of charge and/or current P2, which may include power consumption, such as thermal design power, electrical design power, or average power consumption in various time periods, for example, as indicated by the time ranges TR2, TR3, and TR4. For example, time range TR2 may represent time windows of 20 to 100 nanoseconds (ns), time range TR3 may represent windows of 1 to 2 microseconds (μs), and time range TR 4 may represent windows of time from 5 to 20 milliseconds (ms). These time ranges TR1-TR5 are merely representative of any number of different ranges that may be programmable. Alternatively, the STCs 502(2)-502(4) may monitor average current to the plurality of logic circuits in various time periods or total power consumption in the plurality of logic circuits in various time periods.

As indicated in chart 500, the STCs 502(5)-502(8) monitor power/energy P3, which may include power consumption over various windows of time including one represented by time range TR5, which may be 1 to 2 ms, for example. The STC 502(9) in time range TR5 indicates that temperatures need to be monitored over a longer period of time. The STCs 502(1)-502(9) are merely examples and any of them may be omitted, modified or duplicated in a power management circuit 302.

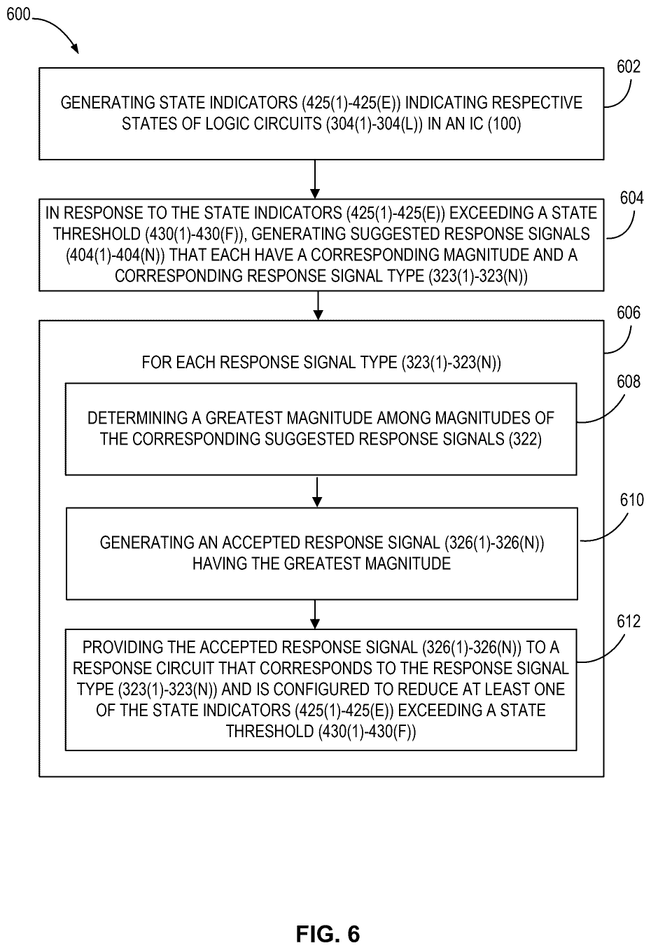

FIG. 6 is a flowchart of a method 600 of a power management circuit 302 in an integrated circuit (IC) 100. The method includes generating state indicators 425(1)-425(E) indicating respective states of logic circuits 304(1)-304(L) in an IC 100 (block 602) and in response to the state indicators 425(1)-425(E) exceeding a state threshold 430(1)-430(F), generating suggested response signals 404(1)-404(N) that each have a corresponding magnitude and a corresponding response signal type 323(1)-323(N) (block 604). The method also includes, for each response signal type 323(1)-323(N) (block 606), determining a greatest magnitude among magnitudes of the corresponding suggested response signals 322 (block 608), generating an accepted response signal 326(1)-326(N) having the greatest magnitude (block 610), and providing the accepted response signal 326(1)-326(N) to a response circuit that corresponds to the response signal type 323(1)-323(N) and is configured to reduce at least one of the state indicators 425(1)-425(E) exceeding a state threshold 430(1)-430(F) (block 612).

Examples of such processor-based devices, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

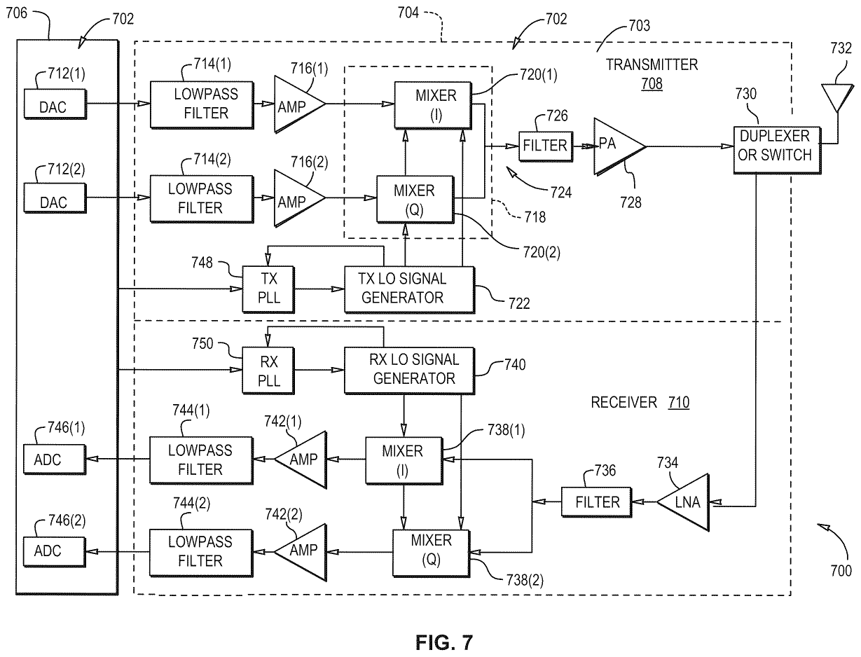

FIG. 7 illustrates an exemplary wireless communications device 700 that includes radio-frequency (RF) components formed from one or more ICs 702, wherein any of the ICs 702 may include clusters of logic circuits, such as processor cores, that include exemplary power management circuits to monitor circuit states and generate control signals with low latency to adjust circuit activity and maintain a higher level of performance, as shown in FIGS. 1-4. The wireless communications device 700 may include or be provided in any of the above-referenced devices, as examples. As shown in FIG. 7, the wireless communications device 700 includes a transceiver 704 and a data processor 706. The data processor 706 may include a memory to store data and program codes. The transceiver 704 includes a transmitter 708 and a receiver 710 that support bi-directional communications. In general, the wireless communications device 700 may include any number of transmitters 708 and/or receivers 710 for any number of communication systems and frequency bands. All or a portion of the transceiver 704 may be implemented on one or more analog ICs, RF ICs (RFICs), mixed-signal ICs, etc.

The transmitter 708 or the receiver 710 may be implemented with a super-heterodyne architecture or a direct-conversion architecture. In the super-heterodyne architecture, a signal is frequency-converted between RF and baseband in multiple stages, for example, from RF to an intermediate frequency (IF) in one stage and then from IF to baseband in another stage for the receiver 710. In the direct-conversion architecture, a signal is frequency-converted between RF and baseband in one stage. The super-heterodyne and direct-conversion architectures may use different circuit blocks and/or have different requirements. In the wireless communications device 700 in FIG. 7, the transmitter 708 and the receiver 710 are implemented with the direct-conversion architecture.

In the transmit path, the data processor 706 processes data to be transmitted and provides I and Q analog output signals to the transmitter 708. In the exemplary wireless communications device 700, the data processor 706 includes digital-to-analog converters (DACs) 712(1), 712(2) for converting digital signals generated by the data processor 706 into the I and Q analog output signals (e.g., I and Q output currents) for further processing.

Within the transmitter 708, lowpass filters 714(1), 714(2) filter the I and Q analog output signals, respectively, to remove undesired signals caused by the prior digital-to-analog conversion. Amplifiers (AMPs) 716(1), 716(2) amplify the signals from the lowpass filters 714(1), 714(2), respectively, and provide I and Q baseband signals. An upconverter 718 upconverts the I and Q baseband signals with I and Q transmit (TX) local oscillator (LO) signals through mixers 720(1), 720(2) from a TX LO signal generator 722 to provide an upconverted signal 724. A filter 726 filters the upconverted signal 724 to remove undesired signals caused by the frequency up-conversion as well as noise in a receive frequency band. A power amplifier (PA) 728 amplifies the upconverted signal 724 from the filter 726 to obtain the desired output power level and provides a transmit RF signal. The transmit RF signal is routed through a duplexer or switch 730 and transmitted via an antenna 732.

In the receive path, the antenna 732 receives signals transmitted by base stations and provides a received RF signal, which is routed through the duplexer or switch 730 and provided to a low noise amplifier (LNA) 734. The duplexer or switch 730 is designed to operate with a specific receive (RX)-to-TX duplexer frequency separation, such that RX signals are isolated from TX signals. The received RF signal is amplified by the LNA 734 and filtered by a filter 736 to obtain a desired RF input signal. Down-conversion mixers 738(1), 738(2) mix the output of the filter 736 with I and Q RX LO signals (i.e., LO_I and LO_Q) from an RX LO signal generator 740 to generate I and Q baseband signals. The I and Q baseband signals are amplified by AMPs 742(1), 742(2) and further filtered by lowpass filters 744(1), 744(2) to obtain I and Q analog input signals, which are provided to the data processor 706. In this example, the data processor 706 includes analog-to-digital converters (ADCs) 746(1), 746(2) for converting the analog input signals into digital signals to be further processed by the data processor 706.

In the wireless communications device 700 of FIG. 7, the TX LO signal generator 722 generates the I and Q TX LO signals used for frequency up-conversion, while the RX LO signal generator 740 generates the I and Q RX LO signals used for frequency down-conversion. Each LO signal is a periodic signal with a particular fundamental frequency. A TX phase-locked loop (PLL) circuit 748 receives timing information from the data processor 706 and generates a control signal used to adjust the frequency and/or phase of the TX LO signals from the TX LO signal generator 722. Similarly, an RX PLL circuit 750 receives timing information from the data processor 706 and generates a control signal used to adjust the frequency and/or phase of the RX LO signals from the RX LO signal generator 740.

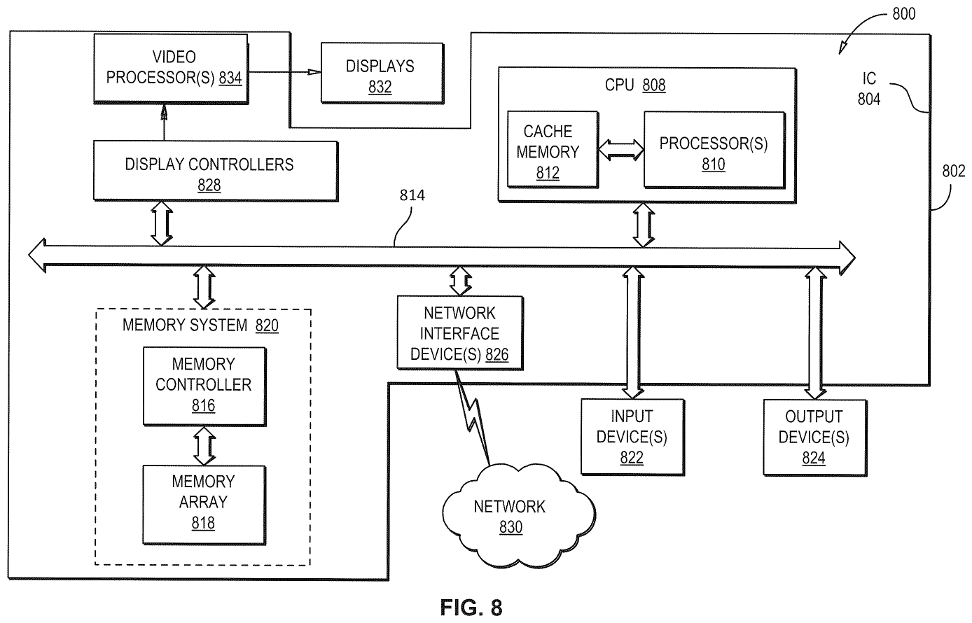

In this regard, FIG. 8 illustrates an example of a processor-based system 800 that can include clusters of logic circuits, such as processor cores, that include exemplary power management circuits to monitor circuit states and generate control signals with low latency to adjust circuit activity and maintain a higher level of performance, as shown in FIGS. 1-4. The processor-based system 800 includes a central processing unit (CPU) 808 that includes one or more processors 810, which may also be referred to as CPU cores or processor cores. The CPU 808 may have cache memory 812 coupled to the CPU 808 for rapid access to temporarily stored data. The CPU 808 is coupled to a system bus 814 and can intercouple master and slave devices included in the processor-based system 800. As is well known, the CPU 808 communicates with these other devices by exchanging address, control, and data information over the system bus 814. For example, the CPU 808 can communicate bus transaction requests to a memory controller 816, as an example of a slave device. Although not illustrated in FIG. 8, multiple system buses 814 could be provided, wherein each system bus 814 constitutes a different fabric.

Other master and slave devices can be connected to the system bus 814. As illustrated in FIG. 8, these devices can include a memory system 820 that includes the memory controller 816 and a memory array(s) 818, one or more input devices 822, one or more output devices 824, one or more network interface devices 826, and one or more display controllers 828, as examples. The input device(s) 822 can include any type of input device, including, but not limited to, input keys, switches, voice processors, etc. The output device(s) 824 can include any type of output device, including, but not limited to, audio, video, other visual indicators, etc. The network interface device(s) 826 can be any device configured to allow an exchange of data to and from a network 830. The network 830 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 826 can be configured to support any type of communications protocol desired.

The CPU 808 may also be configured to access the display controller(s) 828 over the system bus 814 to control information sent to one or more displays 832. The display controller(s) 828 sends information to the display(s) 832 to be displayed via one or more video processor(s) 834, which processes the information to be displayed into a format suitable for the display(s) 832. The display(s) 832 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium wherein any such instructions are executed by a processor or other processing device, or combinations of both. The devices and components described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from and write information to the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

It should be understood that the terms “first,” “second,” “third,” etc., where used herein, are relative terms that may be used to distinguish between similarly named elements and are not meant to limit or imply a strict orientation and/or order unless otherwise specified. It should also be understood that that the terms “top,” “upper,” “above,” and “bottom,” “lower,” “below,” where used herein, are relative terms and are not meant to limit or imply a strict orientation. A “top” or “upper” or “above” referenced element does not always need to be oriented to be above a “bottom,” or “lower,” or “below” referenced element with respect to ground, and vice versa. An element referenced as “top,” “upper,” “above,” or “bottom,” “lower,” “below,” may be on top or bottom relative to that example only and the particular illustrated example. An element referenced as “top” or “upper” or “above” “bottom,” “lower,” “below,” another element does not have to be with respect to ground, and vice versa. An element referenced as “top” or “upper” or “above” may be above or below such other referenced element, relative to that example only and the particular illustrated example. For example, if a particular object that is discussed as at “top,” or “upper” or “above” another object, and such particular object is flipped 180 degrees, then such particular object would then be oriented as at “bottom,” or “lower” or “below” such other object.

Further, an object being “adjacent” as discussed herein relates to an object being beside or next to another stated object. Adjacent objects may not be directly physically coupled to each other. An object can be directly adjacent to another object which means that such objects are directly beside or next to the other object without another object or layer being intervening or disposed between the directly adjacent objects. An object can be indirectly or non-directly adjacent to another object which means that such objects are not directly beside or directly next to each other, but there is an intervening object or layer disposed between the non-directly adjacent objects.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

Implementation examples are described in the following numbered clauses:
1. An integrated circuit (IC) comprising a power management circuit configured to:
   generate state indicators indicating respective states of logic circuits in an IC;
   in response to the state indicators exceeding a state threshold, generate suggested response signals that each have a corresponding magnitude and a corresponding response signal type; and
   for each response signal type:
      determine a greatest magnitude among magnitudes of the corresponding suggested response signals;
      generate an accepted response signal having the greatest magnitude; and
      provide the accepted response signal to a response circuit that corresponds to the response signal type and is configured to reduce at least one of the state indicators exceeding the state threshold.
2. The IC of clause 1, wherein the power management circuit is further configured to:
   generate an aggregated activity indicator from aggregated indications of activity in each of a plurality of logic circuits; and
   generate the state indicators based on the aggregated activity indicator.
3. The IC of clause 1 or clause 2, wherein for each response signal type, the response circuit comprises one of the logic circuits, a clock control circuit, or a voltage control circuit.
4. The IC of any of clause 1 to clause 3, wherein the power management circuit is further configured to provide the accepted response signal for at least two of the response signal types to the corresponding response circuits in parallel.
5. The IC of any of clause 1 to clause 4, wherein the power management circuit further comprises a plurality of state tracker circuits configured to generate, based on the aggregated activity indicator, the state indicators indicating a plurality of states in the plurality of logic circuits.
6. The IC of clause 5, wherein each of the plurality of state tracker circuits is programmable to generate one or more of the suggested response signals, each having a response signal type of a plurality of response signal types.
7. The IC of clause 5 or clause 6, wherein the plurality of state tracker circuits is configured to generate, based on the aggregated activity indicator, the state indicators indicating two or more of a rate of change of current (di/dt), average power consumption of the plurality of logic circuits in a first time period, average current provided to the plurality of logic circuits in a second time period, total power consumption of the plurality of logic circuits in a third time period, rate of temperature change, and temperature.
8. The IC of any of clause 1 to clause 7, wherein the power management circuit is further configured to:
   compare a first state indicator of the state indicators to at least one threshold; and
   adjust a magnitude of at least one of the suggested response signals based on one or more of the state thresholds being exceeded by the first state indicator.
9. The IC of any of clause 1 to clause 8, wherein the power management circuit further comprises voting circuits further configured to generate the accepted response signal of a first type to have a secondary magnitude equal to a greatest magnitude among the suggested response signals of the first type.
10. The IC of any of clause 1 to clause 9, wherein the accepted response signals comprise a throttle signal to reduce frequency of the activity in the plurality of logic circuits.
11. The IC of any of clause 1 to clause 10, wherein the accepted response signals comprise:
   a first cluster power signal to a first cluster-level power control circuit providing a first power signal to the plurality of logic circuits; and
   a second cluster power signal to a second cluster-level power control circuit providing a second power signal to the plurality of logic circuits.
12. The IC of any of clause 1 to clause 1, wherein the accepted response signals comprise:
   a clock control signal to a clock control circuit providing a clock signal to the plurality of logic circuits; and
   a power control signal to a cluster-level power control circuit providing a power signal to the plurality of logic circuits.
13. The IC of any of clause 1 to clause 12, wherein the accepted response signals comprise:
   a firmware control signal to trigger a firmware response; and
   an IC power signal to an IC power circuit.
14. The IC of any of clause 1 to clause 13, wherein the plurality of logic circuits comprises a plurality of processor cores and a cache memory circuit.
15. The IC of any of clause 1 to clause 14 integrated into a device selected from the group consisting of: a set-top box; an entertainment unit; a navigation device; a communications device; a fixed location data unit; a mobile location data unit; a global positioning system (GPS) device; a mobile phone; a cellular phone; a smartphone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; an avionics system; a drone; and a multicopter.
16. A method of a power management circuit in an integrated circuit (IC), the method comprising:
   generating state indicators that each indicate one of a plurality of states of a plurality of logic circuits in an IC;
   in response to the state indicators exceeding a state threshold, generating suggested response signals, wherein each suggested response signal has a corresponding magnitude and a corresponding response signal type; and
   for each response signal type:
      determining a greatest magnitude among magnitudes of the corresponding suggested response signals;
      generating an accepted response signal having the greatest magnitude; and
      providing the accepted response signal to a response circuit that corresponds to the response signal type and is configured to reduce at least one of the state indicators exceeding a state threshold.
17. The method of clause 16, further comprising providing the accepted response signal of at least two response signal types to the corresponding response circuits in parallel.
18. The method of clause 16 or clause 17, further comprising, in a programmable state tracker circuit corresponding to each state of the plurality of states in the plurality of logic circuits:
   the state indicator of the corresponding state; and
   the suggested response signals having any one or more response signal type of a plurality of response signal types in response to the state indicator exceeding the state threshold.
19. The method of any of clause 16 to clause 18, wherein the state indicators indicate two or more of a rate of change of current (di/dt), average power consumption of the plurality of logic circuits in a first time period, current provided to the plurality of logic circuits in a second time period, total power consumption of the plurality of logic circuits in a third time period, rate of temperature change, and temperature.
20. The method of any of clause 16 to clause 19, further comprising:
   comparing a first state indicator of the state indicators to at least one threshold; and
   adjusting a magnitude of at least one of the suggested response signals based on the thresholds exceeded by the first state indicator.

What is claimed is:

1. An integrated circuit (IC) comprising a power management circuit configured to:
generate state indicators indicating respective states of logic circuits in an IC;
in response to the state indicators exceeding a state threshold, generate suggested response signals that each have a corresponding magnitude and a corresponding response signal type; and
for each response signal type:
determine a greatest magnitude among magnitudes of the corresponding suggested response signals;
generate an accepted response signal having the greatest magnitude; and
provide the accepted response signal to a response circuit that corresponds to the response signal type and is configured to reduce at least one of the state indicators exceeding the state threshold.

2. The IC of claim 1, wherein the power management circuit is further configured to:
generate an aggregated activity indicator from aggregated indications of activity in each of a plurality of logic circuits; and
generate the state indicators based on the aggregated activity indicator.

3. The IC of claim 1, wherein for each response signal type, the response circuit comprises one of the logic circuits, a clock control circuit, or a voltage control circuit.

4. The IC of claim 1, wherein the power management circuit is further configured to provide the accepted response signal for at least two of the response signal types to the corresponding response circuits in parallel.

5. The IC of claim 2, wherein the power management circuit further comprises a plurality of state tracker circuits configured to generate, based on the aggregated activity indicator, the state indicators indicating a plurality of states in the plurality of logic circuits.

6. The IC of claim 5, wherein each of the plurality of state tracker circuits is programmable to generate one or more of the suggested response signals, each having a response signal type of a plurality of response signal types.

7. The IC of claim 6, wherein the plurality of state tracker circuits is configured to generate, based on the aggregated activity indicator, the state indicators indicating two or more of a rate of change of current (di/dt), average power consumption of the plurality of logic circuits in a first time period, average current provided to the plurality of logic circuits in a second time period, total power consumption of the plurality of logic circuits in a third time period, rate of temperature change, and temperature.

8. The IC of claim 1, wherein the power management circuit is further configured to:
compare a first state indicator of the state indicators to at least one threshold; and
adjust a magnitude of at least one of the suggested response signals based on one or more of the state thresholds being exceeded by the first state indicator.

9. The IC of claim 1, wherein the power management circuit further comprises voting circuits further configured to generate the accepted response signal of a first type to have a secondary magnitude equal to a greatest magnitude among the suggested response signals of the first type.

10. The IC of claim 2, wherein the accepted response signals comprise a throttle signal to throttle the activity in the plurality of logic circuits.

11. The IC of claim 2, wherein the accepted response signals comprise:
a first cluster power signal to a first cluster-level power control circuit providing a first power signal to the plurality of logic circuits; and
a second cluster power signal to a second cluster-level power control circuit providing a second power signal to the plurality of logic circuits.

12. The IC of claim 1, wherein the accepted response signals comprise:
a clock control signal to a clock control circuit providing a clock signal to the plurality of logic circuits; and
a power control signal to a cluster-level power control circuit providing a power signal to the plurality of logic circuits.

13. The IC of claim 1, wherein the accepted response signals comprise:
a firmware control signal to trigger a firmware response; and
an IC power signal to an IC power circuit.

14. The IC of claim 1, wherein the plurality of logic circuits comprises a plurality of processor cores and a cache memory circuit.

15. The IC of claim 1 integrated into a device selected from the group consisting of: a set-top box; an entertainment unit; a navigation device; a communications device; a fixed location data unit; a mobile location data unit; a global positioning system (GPS) device; a mobile phone; a cellular phone; a smartphone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; an avionics system; a drone; and a multicopter.

16. A method of a power management circuit in an integrated circuit (IC), the method comprising:
generating state indicators that each indicate one of a plurality of states of a plurality of logic circuits in an IC;
in response to the state indicators exceeding a state threshold, generating suggested response signals, wherein each suggested response signal has a corresponding magnitude and a corresponding response signal type; and
for each response signal type:
determining a greatest magnitude among magnitudes of the corresponding suggested response signals;
generating an accepted response signal having the greatest magnitude; and
providing the accepted response signal to a response circuit that corresponds to the response signal type and is configured to reduce at least one of the state indicators exceeding a state threshold.

17. The method of claim 16, further comprising providing the accepted response signal of at least two response signal types to the corresponding response circuits in parallel.

18. The method of claim 16, further comprising generating, by a programmable state tracker circuit corresponding to each state of the plurality of states in the plurality of logic circuits:
the state indicator of the corresponding state; and
the suggested response signals having any one or more response signal type of the response signal types in response to the state indicator exceeding a threshold.

19. The method of claim 16, wherein the state indicators indicate two or more of a rate of change of current (di/dt), average power consumption of the plurality of logic circuits in a first time period, current provided to the plurality of logic circuits in a second time period, total power consumption of the plurality of logic circuits in a third time period, rate of temperature change, and temperature.

20. The method of claim 15, further comprising:
comparing a first state indicator of the state indicators to at least one threshold; and
adjusting a magnitude of at least one of the suggested response signals based on the thresholds exceeded by the first state indicator.
